(19) United States
(12) Patent Application Publication
(10) Pub. No.: US 2022/0057944 A1
(43) Pub. Date: Feb. 24, 2022

(54) TRIM DETERMINATION BASED ON POWER AVAILABILITY

(71) Applicant: Micron Technology, Inc., Boise, ID (US)

(72) Inventors: Jeremy Binfet, Boise, ID (US); Niccolo' Righetti, Boise, ID (US); Jeffrey S. McNeil, JR., Nampa, ID (US); Akira Goda, Setagaya (JP); Todd A. Marquart, Boise, ID (US); Mark A. Helm, Santa Cruz, CA (US); Gil Golov, Backnang (DE); Kishore K. Muchherla, Fremont, CA (US); Carmine Miccoli, Boise, ID (US); Giuseppina Puzzilli, Boise, ID (US)

(21) Appl. No.: 17/001,121

(22) Filed: Aug. 24, 2020

(51) Int. Cl. G06F 3/06

(52) U.S. Cl. CPC G06F 3/0625; G06F 3/0679; G06F 3/0655

(57) ABSTRACT

A system includes a processing device and a memory device coupled to the processing device. The memory device is further coupled to the processing device and to a primary power supply and a secondary power supply. The processing device is to determine, based at least in part on availability of the primary power supply to the memory device, whether to operate the memory device with a first trim tailored to data reliability or a second trim tailored to programming time. The processing device is further to operate the memory device with the determined one of the first trim or the second trim.

### TECHNICAL FIELD

Embodiments of the disclosure relate generally to memory systems and more specifically relate to trim determination based on power availability.

### BACKGROUND

A memory system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIG. 2 illustrates an example of a memory device including a cyclic buffer and/or a snapshot within a memory device in accordance with some embodiments of the present disclosure.

FIG. 3 is a flow diagram of an example method for using different trims based on availability of power supply in accordance with some embodiments of the present disclosure.

FIG. 4 illustrates an example of a system including a computing system in a vehicle in accordance with some embodiments of the present disclosure.

FIG. 5 is a block diagram of an example computer system in which embodiments of the present disclosure may operate.

### DETAILED DESCRIPTION

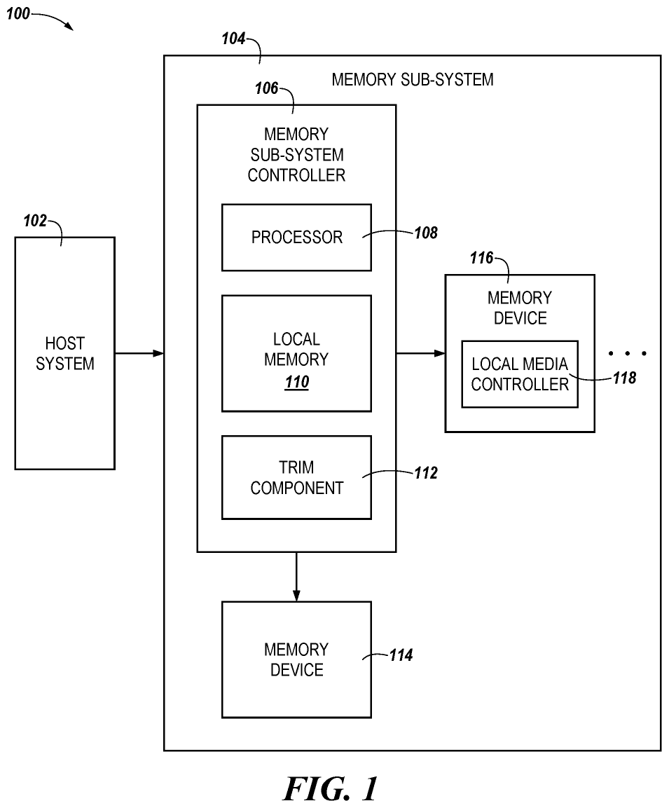

A memory sub-system can be a storage device, a memory module, or a hybrid of a storage device and memory module. Examples of storage devices and memory modules are described below in conjunction with FIG. 1. In general, a host system can utilize a memory sub-system that includes one or more memory devices, such as memory devices that store data. The host system can provide data to be stored at the memory sub-system and can request data to be retrieved from the memory sub-system.

The emergence of autonomous vehicles, Internet of Things (IoT) and surveillance devices has resulted in a wider gap in between the total bytes written (TBW) in a useable lifetime of a memory sub-system and a user capacity of the memory sub-system. For example, the TBW to user capacity ratio for some memory sub-systems used for such applications has increased by one to three orders of magnitude (e.g., from 1,000-5,000 TBW to user capacity ratios to 500,000-1,000,000 TBW to user capacity ratios). For instance, some autonomous vehicles require real time buffering of telemetric data captured by video cameras, radar, lidar, ultra-sonic and other sensors to playback sequences preceding an accident involving the vehicle. The data from these sensors can sum up to a substantial throughput requirement (e.g., a one GigaByte per second (GB/sec) sequential write throughput) from a host. Upon a trigger event, a quantity of buffered data corresponding to a predetermined playback time (e.g., thirty seconds) immediately preceding the event needs to be captured to determine the cause of an accident. A playback can be referred to as a “snapshot”.

Accordingly, an accident data recorder (e.g., a black box) for a vehicle (e.g., an autonomous vehicle) can be one application in which the user capacity requirement is low (e.g., 128 GB), but the TBW is high (e.g., hundreds of PetaBytes). For example, in some use cases a black box can store a number of most recent snapshots, such as, for instance, eight snapshots equating to 240 GB (e.g., 1 GB/second×30 seconds×8 snapshots). A useable lifetime of a memory sub-system in this example can be five years or approximately forty-five thousand 45,000 hours. At a sensor data capture rate of 1 GB/second, this equates to hundreds of PetaBytes as a measure of TBW. The examples of such values given are not intended to be limiting, but rather highlight the relative difference between the requirements for user capacity and TBW in such an application.

The memory sub-system of the black box can be desired to be flexible in achieving different performance targets based on various circumstances. For example, a desired performance target can be a faster programming time when no stable power supply is available to the memory sub-system. On the other hand, a desired performance target can be increased data reliability when power can be stably available to the memory sub-system. Since a faster programming time can be achieved at the cost of data reliability (alternatively speaking, data reliability can be achieved at the cost of a programming time), the memory sub-system can be desired to flexibly switch between the two depending on the availability of the stable power supply, which has been substantially challenging in previous approaches.

Aspects of the present disclosure address the above and other deficiencies by flexibly adjusting a performance target of a memory sub-system based on availability of a primary power supply, which is designed to provide relatively stable power to the memory sub-system. For example, if the primary power supply is not available in response to a trigger event, the snapshot can be copied from one memory portion (e.g., buffer portion) to another memory portion (e.g., snapshot portion) of the memory sub-system of the black box using a trim tailored to a performance target of a faster programming time. Alternatively if the primary power supply is still available, for example, despite of the trigger event, the snapshot can be copied using a trim tailored to a performance target of increased data reliability. Such an approach avoids a situation where data reliability needs not be sacrificed for the benefit of achieving a faster programming time when the snapshot is not required/desired to be copied relatively quickly.

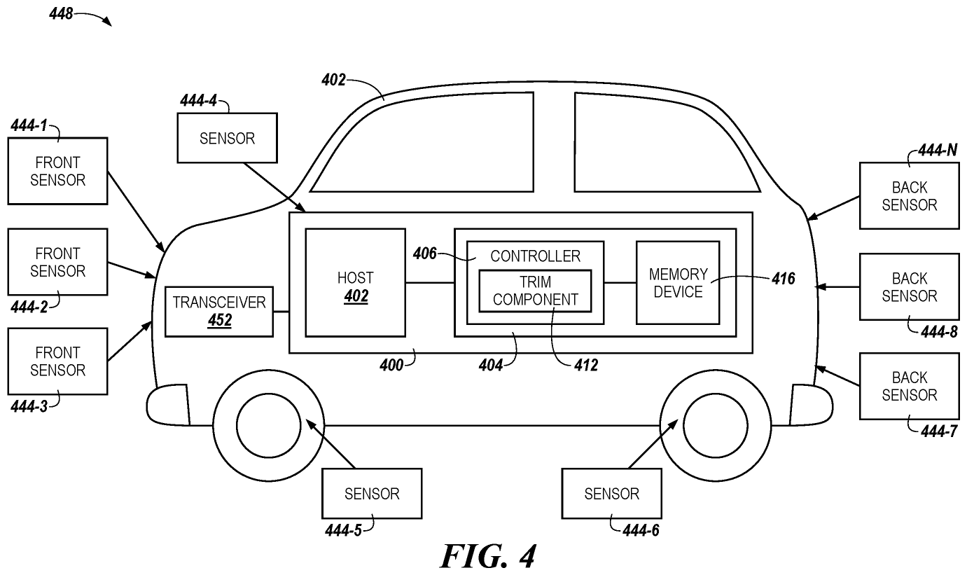

The figures herein follow a numbering convention in which the first digit or digits correspond to the drawing figure number and the remaining digits identify an element or component in the drawing. Similar elements or components between different figures can be identified by the use of similar digits. For example, 106 can reference element “06” in FIG. 1, and a similar element can be referenced as 406 in FIG. 4. Analogous elements within a Figure may be referenced with a hyphen and extra numeral or letter. Such analogous elements may be generally referenced without the hyphen and extra numeral or letter. For example, elements 444-1, . . . , 444-N in FIG. 4 may be collectively referenced as 404. As used herein, the designators “B”, “N”, “P”, “R”, and “S”, particularly with respect to reference numerals in the drawings, indicates that a number of the particular feature so designated can be included. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

FIG. 1 illustrates an example computing system 100 that includes a memory sub-system 104 in accordance with some embodiments of the present disclosure. The memory sub-system 104 can include media, such as one or more volatile memory devices (e.g., memory device 114), one or more non-volatile memory devices (e.g., memory device 116), or a combination of such.

A memory sub-system 104 can be a storage device, a memory module, or a hybrid of a storage device and memory module. Examples of a storage device include an SSD, a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), IoT enabled device, embedded computer (e.g., one included in a vehicle, industrial equipment, or a networked commercial device), or similar computing system that includes memory and a processing device.

The computing system 100 includes a host system 102 that is coupled to one or more memory sub-systems 104. In some embodiments, the host system 102 is coupled to different types of memory sub-systems 104. FIG. 1 illustrates one example of a host system 102 coupled to one memory sub-system 104. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

In at least one embodiment, the host system 102 is a computing device that controls a vehicle, such as an autonomous vehicle, and the memory sub-system 104 is an SSD that provides black box storage for the vehicle. For example, the memory sub-system 104 can store time based telemetric sensor data for the vehicle. Embodiments are not limited to this example.

The host system 102 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, etc.). The host system 102 uses the memory sub-system 104, for example, to write data to the memory sub-system 104 and read data from the memory sub-system 104.

The host system 102 can be coupled to the memory sub-system 104 via a physical host interface. Examples of a physical host interface include, but are not limited to, a serial advanced technology attachment (SATA) interface, a PCIe interface, universal serial bus (USB) interface, Fibre Channel, Serial Attached SCSI (SAS), Small Computer System Interface (SCSI), a double data rate (DDR) memory bus, a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), or any other interface. The physical host interface can be used to transmit data between the host system 102 and the memory sub-system 104. The host system 102 can further utilize an NVM Express (NVMe) interface to access components (e.g., memory devices 116) when the memory sub-system 104 is coupled with the host system 102 by the PCIe interface. The physical host interface can provide an interface for passing control, address, data, and other signals between the memory sub-system 104 and the host system 102. FIG. 1 illustrates a memory sub-system 104 as an example. In general, the host system 102 can access multiple memory sub-systems via a same communication connection, multiple separate communication connections, and/or a combination of communication connections.

The host system 102 can send requests to the memory sub-system 104, for example, to store data in the memory sub-system 104 or to read data from the memory sub-system 104. The data to be written or read, as specified by a host request, is referred to as “host data.” A host request can include logical address information. The logical address information can be a logical block address (LBA), which can include or be accompanied by a partition number. The logical address information is the location the host system associates with the host data. The logical address information can be part of metadata for the host data. The LBA can also correspond (e.g., dynamically map) to a physical address, such as a physical block address (PBA), that indicates the physical location where the host data is stored in memory.

Some examples of non-volatile memory devices (e.g., memory device 116) include negative-and (NAND) type flash memory and write-in-place memory, such as three-dimensional cross-point memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 114 and 116 can include one or more arrays of memory cells. One method of operating a memory cell includes storing one-bit per cell, which is referred to as a single level cell (SLC). The “level” refers to the quantity of states to which the cell is programed, other than an erased state (level). An SLC can be programmed to one level other than the erased level. Other methods of operating memory cells include storing more than one bit per cell, such as multi-level cells (MLCs), triple level cells (TLCs), quad-level cells (QLCs), and penta-level cells (PLCs), among others. As used herein, “multi-level cells (MLCs)” refers to a memory cell that is programmable to two levels other than an erased level. In some embodiments, the non-volatile memory device 116 can include one or more arrays of memory cells such as SLCs, MLCs, TLCs, QLCs, PLCs, or any combination of such. In some embodiments, a particular memory device can include an SLC portion, and an MLC portion, a TLC portion, a QLC portion, or a PLC portion of memory cells. The memory cells of the non-volatile memory device 116 can be grouped as pages that can refer to a logical unit of the memory device used to store data. With some types of memory (e.g., NAND), pages can be grouped to form blocks.

Although non-volatile memory components such as three-dimensional cross-point arrays of non-volatile memory cells and NAND type memory (e.g., 2D NAND, 3D NAND) are described, the memory device 116 can be based on any other type of non-volatile memory or storage device, such as such as, read-only memory (ROM), phase change memory (PCM), self-selecting memory, other chalcogenide based memories, ferroelectric transistor random-access memory (FeTRAM),ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

The memory sub-system controller 106 (or controller 106 for simplicity) can communicate with the memory device 116 to perform operations such as reading data, writing data, erasing data, and other such operations at the non-volatile memory device 116. The memory sub-system controller 106 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 106 can be a microcontroller, special purpose logic circuitry (e.g., a field programmable gate array (FPGA), an application specific integrated circuit (ASIC), etc.), or other suitable circuitry.

The memory sub-system controller 106 can include a processor 108 (e.g., a processing device) configured to execute instructions stored in a local memory 110. In the illustrated example, the local memory 110 of the memory sub-system controller 106 includes an embedded memory configured to store instructions for performing various processes, operations, logic flows, and routines that control operation of the memory sub-system 104, including handling communications between the memory sub-system 104 and the host system 102.

In some embodiments, the local memory 110 can include memory registers storing memory pointers, fetched data, etc. The local memory 110 can also include ROM for storing micro-code, for example. While the example memory sub-system 104 in FIG. 1 has been illustrated as including the memory sub-system controller 106, in another embodiment of the present disclosure, a memory sub-system 104 does not include a memory sub-system controller 106, and can instead rely upon external control (e.g., provided by an external host, or by a processor or controller separate from the memory sub-system 104).

In general, the memory sub-system controller 106 can receive commands or operations from the host system 102 and can convert the commands or operations into instructions or appropriate commands to achieve the desired access to the memory device 116 and/or the memory device 114. The memory sub-system controller 106 can be responsible for other operations such as wear leveling operations, garbage collection operations, error detection and/or correction operations, encryption operations, caching operations, and address translations between a logical address (e.g., LBA, namespace) and a physical address (e.g., physical block address, physical media locations, etc.) associated with the memory device 116. The memory sub-system controller 106 can further include host interface circuitry to communicate with the host system 102 via the physical host interface. The host interface circuitry can convert the commands received from the host system 102 into command instructions to access the memory device 116 and/or the memory device 114 as well as convert responses associated with the memory device 116 and/or the memory device 114 into information for the host system 102.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 106 and decode the address to access the memory device 116 and/or the memory device 114.

In some embodiments, the memory device 116 includes a local media controller 118 that operates in conjunction with memory sub-system controller 106 to execute operations on one or more memory cells of the memory device 116. An external controller (e.g., memory sub-system controller 106) can externally manage the non-volatile memory device 116 (e.g., perform media management operations on the memory device 116). In some embodiments, a memory device 116 is a managed memory device, which is a raw memory device combined with a local controller (e.g., local controller 118) for media management within the same memory device package. An example of a managed memory device is a managed NAND (MNAND) device.

The memory sub-system controller 106 can also include trim component 112. Although not shown in FIG. 1 so as to not obfuscate the drawings, the trim component 112 can include various circuitry to facilitate performance of the operations described herein. For example, the trim component 112 can include a special purpose circuitry in the form of an ASIC, FPGA, state machine, and/or other logic circuitry that can allow the trim component 112 to orchestrate and/or perform the operations described herein. In some embodiments, a local media controller 118 of a non-volatile memory device 116 includes at least a portion of the trim component 112. For example, the local media controller 118 can include a processor (e.g., processing device) configured to execute instructions stored on the memory device 114 for performing the operations described herein with respect to the trim component 112. In some embodiments, the trim component 112 is part of the host system 102, an application, or an operating system.

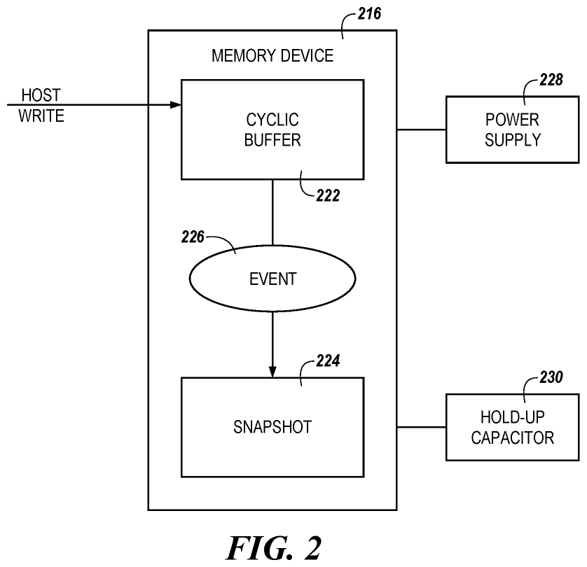

The trim component 112 can be configured to cause memory cells of the memory device 116 to be operated with various trims. In one example, memory cells of the memory device 116 can be operated with a trim tailored to programming time under a certain circumstance, while the same memory cells of the memory device 116 can be operated with a different trim tailored to data reliability under a different circumstance. In another example, memory cells of a cyclic buffer portion (e.g., cyclic buffer portion 222 illustrated in FIG. 2) can be operated with a trim tailored to memory cell endurance and memory cells of a snapshot portion (e.g., snapshot portion 224 illustrated in FIG. 2) can be operated with a trim tailored to data retention. Trims are sets of operating parameters, such as voltages, which can be used to operate memory cells. Although embodiments are not so limited, trims can be stored within the memory sub-system controller 106, such as within the trim component 112. The trim component 112 can issue or cause to be issued a set trim command, which causes the memory device 116 (or portions thereof) to use a particular set of operating parameters to operate the memory cells of the memory device 116. The trim component 112 can further update/alter trims stored within, for example, the trim component 112 to operate memory cells of the memory device 116 with different operating parameters. Trims can include operating parameters associated with various operations such as program (write), program verify, erase, erase verify, and sense (read), among other operations associated with an array of memory cells. Examples of trims include programming voltages, programming frequency, and programming time.

Trims can be used to cause the memory device 116 to be operated with different programing times. Different trims can be used for different operations such as programming, reading, and erasing, to achieve different performance targets such as data reliability (how reliable are data stored in a memory cell), programming time, reading time, data retention over time (how long a memory cell reliably stores the data programmed thereto), and memory cell endurance (how reliably a memory cell operates after various quantities of program/erase cycles). The effects of different trims on different performance targets can be known based on testing, historical observation, theoretical modeling, active monitoring of the operation of a memory device, and other methods. For example, a faster programming time can provide better programming speed, but can yield relatively poor data reliability and/or data retention over time. A slower programming time can provide slower programming speed but can yield better data reliability and/or data retention over time. A faster programming time can also provide for the ability to use a smaller or fewer hold-up capacitors to program a snapshot worth of data.

Examples of trims include a program start voltage, a program step voltage, a program inhibit start voltage, and an erase verify voltage. The program start voltage is the magnitude of an initial programming voltage pulse of a series of voltage pulses applied to a selected word line during a programming operation performed on memory cells in a selected block. The program step voltage is the voltage step size between programming voltage pulses. The program inhibit start voltage is a voltage used to inhibit further programming of memory cells once the threshold voltage (Vt) level associated with a desired data state has been reached. The erase verify voltage is the voltage used to check whether memory cells in the selected block have a Vt level indicative of the erase state.

Other examples of trims include read reference voltages and/or program verify voltages. Program verify voltages represent target voltage levels to which memory cells are to be programmed in order to represent a particular data state. Read reference voltages are voltage levels that can be located between Vt distributions and used to determine a particular data state of a data cell during a data read operation.

In some embodiments, it can be determined whether to operate the non-volatile memory device 116 with a trim tailored to data reliability or a trim tailored to programming time based at least in part on availability of a primary power supply to the memory sub-system 104 and/or the non-volatile memory device 116. As further described in connection with FIG. 2, the memory device 116 can be provided power from a primary power supply (e.g., power supply 228 illustrated in FIG. 2) or from a secondary power supply (e.g., hold-up capacitor 230 illustrated in FIG. 2) in response to a loss of the primary power supply, for example, due to a trigger event. Different trims can be used to operate the non-volatile memory device 116 based on whether the primary power supply is still available in response to a trigger event. As an example, the trim component 112 can update/alter trims stored within the memory sub-system controller 106 (e.g., within the trim component 112) in response to a loss of the primary power supply (e.g., due to a trigger event) to operate the non-volatile memory device 116 with different trim(s) in response to an occurrence of the trigger event. Alternatively, the trim component 112 can maintain trims stored within the memory sub-system controller 106 as long as the primary power supply is still available to the memory sub-system 104 to operate the non-volatile memory device 116 with same trim(s), for example, despite of a trigger event.

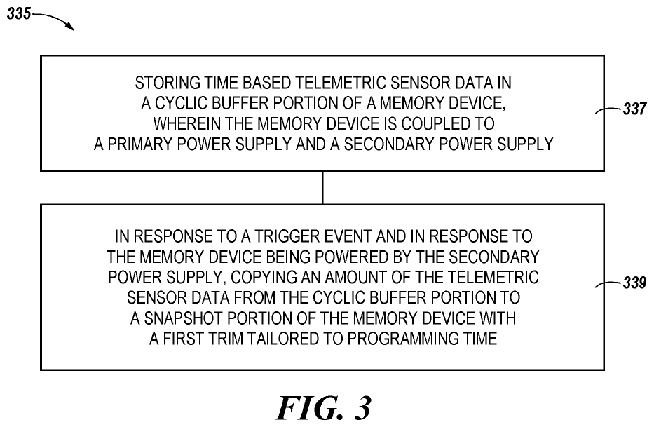

In some embodiments, operating the non-volatile memory device 116 can include copying data stored in one portion (e.g., cyclic buffer portion 222 illustrated in FIG. 2) of the non-volatile memory device 116 to another portion (e.g., snapshot portion 224 illustrated in FIG. 2) of the non-volatile memory device 116 with the determined trim (e.g., trim tailored to data reliability or trim tailored to programming time). The trim tailored to data reliability can provide a relatively high data reliability, while the trim tailored to programming time can provide a relatively low reliability. Further, the trim tailored to programming time can provide a relatively fast programming time, while the trim tailored to data reliability can provide a relatively slow programming time. Further details with regards to using different trims based on availability of a power supply are described in connection with FIG. 3.

FIG. 2 illustrates an example of a memory device 216 including a cyclic buffer portion 222 and a snapshot portion 224 within a memory device 216 in accordance with some embodiments of the present disclosure. The cyclic buffer portion 222 and snapshot portion 224 can be reserved portions of the memory device 216. The cyclic buffer portion 222 and snapshot portion 224 can be within a same partition or within different partitions of the memory device 216. Host data can be received by the memory sub-system. The host data can be time based telemetric sensor data from different sensors of a vehicle. The time based telemetric sensor data from the different sensors can be aggregated by the host and sent to the memory sub-system at a data rate. The host data can be received by the memory sub-system and stored in the cyclic buffer portion 222 of the non-volatile memory device 216. As the cyclic buffer portion 222 is filled with host data, new data received from the host is stored sequentially, but older data in the cyclic buffer portion 222 can be erased or overwritten. The cyclic buffer portion 222 can therefore operate as a first-in-first-out (FIFO) buffer, where newly received data replaced the oldest data therein.

The cyclic buffer portion 222 can be coupled to the snapshot portion 224. Upon occurrence of a trigger event 226, an amount of the time based telemetric sensor data from the cyclic buffer portion 222 can be copied to the snapshot portion 224. The amount of host data corresponding to a defined period of time, which may be referred to as a playback time (e.g., 30 seconds), is referred to as a snapshot size and the data itself over that defined period of time is referred to as a snapshot. The snapshot size can be predefined for a period of time immediately preceding a trigger event. The snapshot size and/or playback time can be a predefined value programmed to the memory sub-system by a manufacturer, supplier, or user of the memory sub-system. In some embodiments, the determination that the trigger event 226 has occurred can include actuation of a trigger signal based at least in part upon received sensor information from a host that is above a threshold, such as a quantitative value.

The cyclic buffer portion 222 can store significantly more data over the service life of the non-volatile memory device 216 than the snapshot portion 224. For example, the cyclic buffer portion 222 can store 3-4 orders of magnitude (1,000-10,000 times) more data than the snapshot portion 224. However, the cyclic buffer portion 222 does not have to have a larger storage capacity than the snapshot portion 224. The size (amount of memory) of the cyclic buffer portion 222 can be dependent, at least in part, on an endurance capability of the cyclic buffer portion 222. For example, if a host is expected to write 150 petabytes (PB) of data to the cyclic buffer portion 222 (TBW is 150 PB) and the endurance capability of the cyclic buffer portion 222 is 5 million PEC, then 30 GB of memory for the cyclic buffer portion 222 is sufficient to satisfy the TBW of 150 PB, provided that data stored by the cyclic buffer portion 222 is overwritten. In contrast, if the endurance capability of the cyclic buffer portion 222 is 500 thousand PEC, then 300 GB of memory for the cyclic buffer portion 222 is necessary to satisfy the TBW of 150 PB. Thus, it can be beneficial to improve (increase) an endurance capability of the non-volatile memory device 216 (e.g., an endurance capability of the cyclic buffer portion 222) so that a higher TBW requirement can be satisfied with a smaller amount of memory. Reducing the amount of memory can reduce manufacturing costs, operating costs, and/or improve performance of the non-volatile memory device 216.

The copying of a snapshot from the cyclic buffer portion 222 to the snapshot portion 224 can be powered by a power supply 228 of the memory sub-system under normal circumstances. However, copying of the snapshot from the cyclic buffer portion 222 to the snapshot portion 224 can be powered by a backup power supply, such as one or more hold-up capacitors 230 in response to a loss of system power (e.g., the power supply 228), which can be associated with the trigger event 226, such as a vehicle accident. In at least one embodiment, the loss of power from the power supply 228 can be the trigger event 226. A size and/or quantity of the hold-up capacitor(s) 230 are sufficient to provide enough power while one snapshot is being copied from the cyclic buffer portion 222 to the snapshot portion 224. As illustrated, the power supply 228 and the hold-up capacitor 230 are coupled to the memory device 216 to provide power therefor. There may not be a direct physical connection between either the power supply 228 or the hold-up capacitor 230 and the partition 220, but the power can be provided through write circuitry (not specifically illustrated).

As an amount of and/or a duration for which power that can provided from the hold-up capacitors 230 can be limited in the absence of the power supply 228, it is desired to operate the snapshot portion 224 according to a performance target of a faster programming time to copy data to the snapshot portion 224 relatively quickly while the power is still being provided from the hold-up capacitors 230. Often, however, the power supply 228 can be still available to provide power for the copy despite of the occurrence of the trigger event, which does not necessitate the hold-up capacitors 230 to provide power to the non-volatile memory device 216. This indicates that, in such a circumstance, the snapshot portion 224 can be operated to achieve a performance target of data reliability (although it can yield relatively slower programming time) because the power supply 228 can provide sufficient power for the copying even with the slower programming time. Accordingly, whether to operate the snapshot portion 224 with a trim tailored to programming time or data reliability can be determined based on availability of the power supply 228.

In some embodiments, once the snapshots are copied to the snapshot portion 224 using a trim tailored to programming time (e.g., faster programming time, which can yield relatively poor data reliability), data reliability of the snapshots can be increased/recovered later when the power supply 228 or another power supply is available again. The data reliability of the snapshots can be increased/recovered as part of performance of a media management operation, such as a garbage collection and/or a data integrity scan operation, which determines whether a particular location of a memory device (e.g., the memory device 216) lacks integrity. As used herein, the term “integrity” can refer to a data quality that indicates a degree of how reliable data is. When performed on the memory device 216, the media management operation can rewrite, with a trim tailored to data reliability, data (e.g., snapshots) previously written to the memory device 216 with a trim tailored to programming time. In some embodiments, the operation to increase/recover data reliability can be actuated based at least in part upon a request from a host. This includes a circumstance where the non-volatile memory device 216 that stores snapshots written with a trim tailored to programming time in response to a trigger event is brought to a service center and provided the power supply 228 or another power supply for recovery of data reliability of the snapshots.

In some embodiments, memory cells of the cyclic buffer portion 222 can be operated so as to store one bit per cell (SLC mode) and memory cells of the snapshot portion 224 can be operated so as to store more than one bit per cell. It can take longer to operate memory cells that store more than one bit per cell than to operate memory cells that store only one bit per cell. For example, an increased number of data states represented by the memory cells having multiple bits per cell can further increase complexity of an algorithm associated with programming, reading, and/or erasing the memory cells. Therefore, the memory cells programmed to store multiple bits per cell can have a different programming characteristic, such as a slower data transfer rate and/or longer programming time (e.g., time elapsed to program data to the memory cells), than that of the SLC memory cells and/or memory cells programmed to store fewer bits per cell. Memory cells of the cyclic buffer portion 222 can be operated with a faster programming time than a programming time for the memory cells of the snapshot portion 224.

FIG. 3 is a flow diagram of an example method 335 for using different trims based on availability of power supply in accordance with some embodiments of the present disclosure. The method can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by or using the memory sub-system controller 106, processing device 108, trim component 112, non-volatile memory device 116 and/or volatile memory device 114, and/or local media controller 118 shown in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 337 of the example method 335, time based telemetric sensor data can be stored in a cyclic buffer portion (e.g., the cyclic buffer 222 illustrated in FIG. 2) of a memory device (e.g., the non-volatile memory device 216 illustrated in FIG. 2). The memory device can be coupled to a primary power supply (e.g., the power supply 228 illustrated in FIG. 2) and a secondary power supply (e.g., the hold-up capacitor 230 illustrated in FIG. 2).

At block 339 of the example method 335, an amount of the telemetric sensor data can be copied from the cyclic buffer portion to a snapshot portion (e.g., the snapshot portion 224 illustrated in FIG. 2) of the memory device with a trim tailored to programming time. The copying of the amount of the telemetric sensor data can be performed in response to a trigger event and in response to the memory device being powered by the secondary power supply.

In some embodiments, copying the amount of the telemetric sensor data from the cyclic buffer portion to the snapshot portion can be performed with a trim tailored to data reliability in response to the memory device being powered by the primary power supply. In some embodiments, the amount of the telemetric sensor data stored in the snapshot portion (e.g., telemetric sensor data previously copied to the snapshot portion using the trim tailored to programming time) can be rewritten to the snapshot portion with the second trim tailored to the data reliability in response to the memory device being powered by the primary power supply again.

FIG. 4 illustrates an example of a system 448 including a computing system 400 in a vehicle 450 in accordance with some embodiments of the present disclosure. The computing system 400 can include a memory sub-system 404, which is illustrated as including a controller 406 and non-volatile memory device 416 for simplicity but is analogous to the memory sub-system 104 illustrated in FIG. 1. The controller 406 can be analogous to the memory sub-system controller 106 illustrated in FIG. 1. The controller 406 can further include a trim component 412 respectively within the controller 406. As described herein, the trim component 412, in some embodiments, can cause the controller 406 to perform operations described to be performed in association with the trim component 112.

The computing system 400, and thus the host 402, can be coupled to a number of sensors 444 either directly, as illustrated for the sensor 444-4 or via a transceiver 452 as illustrated for the sensors 444-1, 444-2, 444-3, 444-5, 444-6, 444-7, 444-8, . . . , 444-N. The transceiver 452 is able to receive time based telemetric sensor data from the sensors 444 wirelessly, such as by radio frequency communication. In at least one embodiment, each of the sensors 444 can communicate with the computing system 400 wirelessly via the transceiver 452. In at least one embodiment, each of the sensors 444 is connected directly to the computing system 400 (e.g., via wires or optical cables). As used herein, telemetric sensor data means that the data is collected by sensors 444 that are remote from the memory sub-system 404 that stores the data (the receiving equipment). The telemetric sensor data is time based because the data is correlated with time. The time corresponding to each data point can either be stored with the telemetric data or derivable therefrom based on some metric, such as a known start time for the data and a data rate. The time can be useful in the playback of the sequences preceding an accident, for example.

The vehicle 450 can be a car (e.g., sedan, van, truck, etc.), a connected vehicle (e.g., a vehicle that has a computing capability to communicate with an external server), an autonomous vehicle (e.g., a vehicle with self-automation capabilities such as self-driving), a drone, a plane, a ship, and/or anything used for transporting people and/or goods. The sensors 444 are illustrated in FIG. 4 as including example attributes. For example, sensors 444-1, 444-2, and 444-3 are camera sensors collecting data from the front of the vehicle 450. Sensors 444-4, 444-5, and 444-6 are microphone sensors collecting data from the front, middle, and back of the vehicle 450. The sensors 444-7, 444-8, and 444-N are camera sensors collecting data from the back of the vehicle 450. As another example, the sensors 444-5, 444-6 are tire pressure sensors. As another example, the sensor 444-4 is a navigation sensor, such as a global positioning system (GPS) receiver. As another example, the sensor 444-6 is a speedometer. As another example, the sensor 444-4 represents a number of engine sensors such as a temperature sensor, a pressure sensor, a voltmeter, an ammeter, a tachometer, a fuel gauge, etc. As another example, the sensor 444-4 represents a video camera.

The host 402 can execute instructions to provide an overall control system and/or operating system for the vehicle 450. The host 402 can be a controller designed to assist in automation endeavors of the vehicle 450. For example, the host 402 can be an advanced driver assistance system controller (ADAS). An ADAS can monitor data to prevent accidents and provide warning of potentially unsafe situations. For example, the ADAS can monitor sensors in the vehicle 450 and take control of vehicle 450 operations to avoid accident or injury (e.g., to avoid accidents in the case of an incapacitated user of a vehicle). The host 402 can be desired to act and make decisions quickly to avoid accidents. The memory sub-system 404 can store reference data in the non-volatile memory device 416 such that time based telemetric sensor data from the sensors 444 can be compared to the reference data by the host 402 in order to make quick decisions.

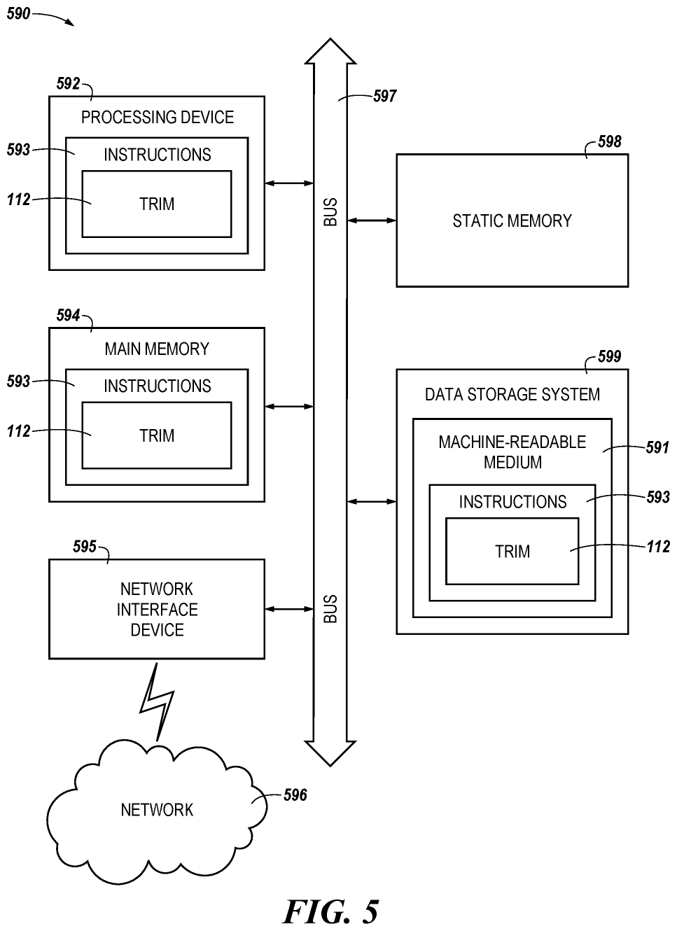

FIG. 5 illustrates an example machine of a computer system 590 within which a set of instructions, for causing the machine to perform one or more of the methodologies discussed herein, can be executed. In some embodiments, the computer system 590 can correspond to a host system (e.g., the host system 102 of FIG. 1) that includes, is coupled to, or utilizes a memory sub-system (e.g., the memory sub-system 104 of FIG. 1) or can be used to perform the operations of a controller (e.g., to execute an operating system to perform operations corresponding to the trim component 112 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or another machine capable of executing a set of instructions (sequential or otherwise) that specify actions to be taken by that machine. Further, while a single machine is illustrated, the term “machine” shall also be taken to include a collection of machines that individually or jointly execute a set (or multiple sets) of instructions to perform one or more of the methodologies discussed herein.

The example computer system 590 includes a processing device 592, a main memory 594 (e.g., read-only memory (ROM), flash memory, dynamic random access memory (DRAM) such as synchronous DRAM (SDRAM) or Rambus DRAM (RDRAM), etc.), a static memory 598 (e.g., flash memory, static random access memory (SRAM), etc.), and a data storage system 599, which communicate with each other via a bus 530.

The processing device 592 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 592 can also be one or more special-purpose processing devices such as an application specific integrated circuit (ASIC), a field programmable gate array (FPGA), a digital signal processor (DSP), network processor, or the like. The processing device 592 is configured to execute instructions 593 for performing the operations and steps discussed herein. The computer system 541 can further include a network interface device 595 to communicate over the network 596.

The data storage system 599 can include a machine-readable storage medium 591 (also known as a computer-readable medium) on which is stored one or more sets of instructions 593 or software embodying one or more of the methodologies or functions described herein. The instructions 593 can also reside, completely or at least partially, within the main memory 594 and/or within the processing device 592 during execution thereof by the computer system 541, the main memory 594 and the processing device 592 also constituting machine-readable storage media. The machine-readable storage medium 591, data storage system 599, and/or main memory 594 can correspond to the memory sub-system 110 of FIG. 1.

In one embodiment, the instructions 593 include instructions to implement functionality corresponding to a touch up component (e.g., trim component 112 of FIG. 1). While the machine-readable storage medium 591 is shown in an example embodiment to be a single medium, the term “machine-readable storage medium” should be taken to include a single medium or multiple media that store the one or more sets of instructions. The term “machine-readable storage medium” shall also be taken to include a medium that is capable of storing or encoding a set of instructions for execution by the machine and that cause the machine to perform one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, types of disk including floppy disks, optical disks, CD-ROMs, and magnetic-optical disks, read-only memories (ROMs), random access memories (RAMs), EPROMs, EEPROMs, magnetic or optical cards, or type of media suitable for storing electronic instructions, each coupled to a computer system bus.

The algorithms and displays presented herein are not inherently related to a particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to a particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes a mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

1. A system comprising:
a processing device; and
a memory device coupled to the processing device and to a primary power supply and a secondary power supply;
wherein the processing device is to:
store, using a first trim tailored to data reliability, telemetric sensor data in a first portion of the memory device;
copy, in response to a trigger event and the memory device being powered by the secondary power supply, the telemetric sensor data to a second portion of the memory device using a second trim tailored to programming time; and
copy, in response to the trigger event and the primary power supply being available despite the trigger event, the telemetric sensor data to the second portion of the memory device using the first trim tailored to programming time.

2. The system of claim 1, wherein the first trim provides a relatively high data reliability; and
wherein the second trim provides a relatively low data reliability.

3. The system of claim 1, wherein the second trim provides a relatively fast programming time; and
wherein the first trim provides a relatively slow programming time.

4. The system of claim 1, wherein:
the memory device comprises non-volatile memory; and
the secondary power supply is to provide power in response to a loss of the primary power supply.

5. (canceled)

6. The system of claim 1, wherein the processing device is further to perform a media management operation on the memory device using the first trim in response to the primary power supply being available.

7. The system of claim 6, wherein the processing device is further to perform the media management operation to rewrite, to the second portion of the memory device using the first trim, the telemetric sensor data previously copied to the second portion of the memory device using the second trim.

8. The system of claim 6, wherein the media management operation comprises a garbage collection operation or a data integrity scan operation.

9. A method, comprising:
storing, using a first trim tailored to data reliability, telemetric sensor data in a cyclic buffer portion of a memory device, wherein the memory device is coupled to a primary power supply and a secondary power supply; and
in response to a trigger event and in response to the memory device being powered by the secondary power supply, copying an amount of the telemetric sensor data from the cyclic buffer portion to a snapshot portion of the memory device tailored to programming time using a second trim tailored to programming time; and
in response to the trigger event and in response to the memory device being powered by the primary power supply, copying the amount of the telemetric sensor data from the cyclic buffer portion to the snapshot portion using the first trim.

10. (canceled)

11. The method of claim 9, further comprising, subsequent to copying the amount of the telemetric sensor data from the cyclic buffer portion to the snapshot portion of the memory device using the second trim:
rewriting, to the snapshot portion, the amount of the telemetric sensor data stored in the snapshot portion with using the first trim in response to the memory device being powered by the primary power supply again.

12. A system comprising:
a processing device; and
a memory device coupled to the processing device and to a primary power supply and a secondary power supply, the memory device including a cyclic buffer portion and a snapshot portion;
wherein the processing device is to:
store, using a first trim tailored to data reliability, telemetric sensor data in the cyclic buffer portion;
in response to a trigger event and in response to the primary power supply being unavailable, copy an amount of the telemetric sensor data from the cyclic buffer portion to the snapshot portion using a second trim tailored to programming time; and
in response to the trigger event and in response to the primary power supply being available, move an amount of the telemetric sensor data within the snapshot portion with using the first trim tailored to data reliability.

13. The system of claim 12, wherein the processing device is further to, in response to the trigger event and in response to the primary power supply being available:
copy the amount of the telemetric sensor data from the cyclic buffer portion to the snapshot portion using the first trim.

14. The system of claim 12, wherein the processing device, subsequent to copying the amount of the telemetric sensor data from the cyclic buffer portion to the snapshot portion using the second trim tailored to the programming time, is further to:
rewrite the amount of the telemetric sensor data to the snapshot portion with the first trim tailored to the data reliability.

15. The system of claim 12, wherein the processing device is further to:
sequentially store new time based telemetric sensor data in the cyclic buffer portion; and
erase older telemetric sensor data.

16. The system of claim 12, wherein the amount of the telemetric sensor data is predefined for a period of time immediately preceding the trigger event.

17. The system of claim 12, wherein the cyclic buffer portion and the snapshot portion are within a same partition of the memory device.

18. The system of claim 12, wherein the cyclic buffer portion and the snapshot portion are within different partitions of the memory device.

19. (canceled)

20. The system of claim 12, wherein the trigger event comprises a vehicle accident.
